(19) United States
(12) Patent Application Publication
(10) Pub. No.: US 2011/0031280 A1
(43) Pub. Date: Feb. 10, 2011

(54) TABLE FEEDER

(75) Inventor: Fumio KATO, Handa-shi (JP)

Correspondence Address: MATTHIAS SCHOLL, 14781 MEMORIAL DRIVE, SUITE 1319, HOUSTON, TX, 77079, US

(73) Assignee: TSUKASA CO., LTD., Handa-shi (JP)

(21) Appl. No.: 12/906,635

(22) Filed: Oct. 18, 2010

Related U.S. Application Data
(63) Continuation of application No. PCT/JP2009/002974, filed on Jun. 27, 2009.

(30) Foreign Application Priority Data
Jul. 1, 2008 (JP) 2008-172430

(51) Int. Cl. G01F 11/20

(52) U.S. Cl. 222/239

(57) ABSTRACT

A table feeder 1 has a bottom assembly 3 of a particulate material processing vessel 2, a discharger 4 provided in the bottom assembly 3 to discharge a particulate material P kept in the vessel 2, a bottom plate 5 included in the bottom assembly 3, a rotating shaft 6 provided vertically to a main face 5a of the bottom plate 5 to rotate on the center of the bottom plate 5, rotary vanes 7 to discharge the particulate material P kept in the particulate material processing vessel 2 via the discharger 4 and a drive device 8 configured to drive and rotate the rotary vanes 7. A cone 10 having a smaller diameter than a diameter of the rotary vanes 7 is provided in the space above the rotary vanes 7 coaxially with the rotary vanes 7 to extend over a central area of the rotary vane 7.

### CROSS-REFERENCE TO RELATED APPLICATIONS

This application is a continuation of International Patent Application No. PCT/JP2009/002974, with an international filing date of Jun. 27, 2009, designating the United States, now pending, and claims foreign priority benefits to Japanese Patent Application No. 2008-172430, filed Jul. 1, 2008. The contents of all of these specifications, including any intervening amendments thereto, are incorporated herein by reference.

### BACKGROUND OF THE INVENTION

1. Field of the Invention

This invention relates to a table feeder disposed on a bottom of a particulate material processing vessel for keeping therein a particulate material, such as a food product, a chemical product, a pharmaceutical product, a cosmetic product, a feedstuff, or a fertilizer.

2. Description of the Related Art

A table feeder is conventionally fastened to a bottom assembly of a particulate material processing vessel for keeping a particulate material therein. The table feeder is used to discharge the particulate material kept in the particulate material processing vessel. The table feeder has a bottom plate for storing any food products, pharmaceutical products, cosmetic products, feedstuff, or fertilizers that have been processed into a particulate material, or their raw materials. The table feeder also includes a discharger formed on the bottom plate to discharge the particulate material and rotary vanes driven and rotated on the bottom plate to guide the particulate material on the bottom plate toward the discharger. The rotary vanes are fastened to a rotating shaft that is driven to rotate by a drive motor located below the bottom plate. The rotating shaft is arranged in a vertical direction on the center of the bottom plate, and the center of the rotary vanes is fixed to the rotating shaft. The particulate material kept in the particulate material processing vessel is discharged out of said vessel via the discharger by means of actuation of the rotary vanes (Japanese Patent Laid-Open No. H08-268558, Japanese Patent Laid-Open No. 2001-63828).

Another proposed technique for discharging the particulate material from said vessel includes inclining the bottom plate such that it is gradually lowered from the center region containing the rotating shaft toward the periphery, similar to an umbrella (Japanese Patent Laid-Open No. 2005-193997).

### SUMMARY OF THE INVENTION

In any of the known structures described in the references listed above, the single discharger is provided on the periphery of the bottom plate. The rotary vanes called blades or scrapers are used to induce a swirling flow among the particulate materials from the center to the periphery of the bottom plate toward the discharger. A relatively large particulate material pressure is accordingly applied to the bottom plate, and the rotary vanes directly receive the particulate material pressure.

There is no structural feature that facilitates the release of the pressure that is built up in the particulate material in this region, and the rotation power of the rotary vanes may be lowered under the force of the built-up pressure. The drive device for the rotary vanes must thus be designed to have a sufficiently large power capacity. A thick bottom plate and a large size drive device are required to provide sufficient resistance against the particulate materials pressure. Particulate material with low fluidity, for example, crystalline materials such as granulated sugar or bran with a significant oil content, may readily aggregate. Aggregation of the particulate material interferes with the smooth rotation of the rotary vanes and may overload the drive device that rotates the rotary vanes.

According to a first aspect of the invention, there is provided a table feeder. The table feeder includes a particulate material processing vessel, a discharger provided in a bottom assembly of the particulate material processing vessel to discharge a particulate material kept in the particulate material processing vessel, a bottom plate included in the bottom assembly, a rotating shaft protruding upward from the bottom plate to rotate at the center of the bottom plate, a rotary vane disposed on the bottom plate to rotate by means of the rotating shaft and to discharge the particulate material kept in the particulate material processing vessel via the discharger, and a drive device configured to drive and rotate the rotary vane. The bottom assembly includes the bottom plate and a side plate coupled with the bottom plate to surround the bottom plate. A cone having a smaller diameter than the diameter of the rotary vane is provided in an upper space of the rotary vane to cover over a center area of the rotary vane.

According to one embodiment of the table feeder, the cone has a through-hole to accommodate a scraping element, which scrapes off the particulate material accumulated and aggregated on an upper face of the cone and causes the scraped particulate material to fall down via the through-hole to a lower face of the cone.

In the specification hereof, the particle material processing vessel may be, for example, a silo, a bunker, a tank, a bin, or a hopper. The terminology processing may represent, for example, storing, stirring, measuring, or blending the particulate matter. A specific example of the bottom assembly is a bottom section of a general hopper. Another embodiment of the bottom assembly is a truncated, reverse pseudo-cone-shaped member with a gradual downward decrease in cross-sectional area and being truncated by a plane oblique to a bottom plane of the cone. The truncated, reverse pseudo-cone shape is defined by a bottom plane of the cone and a truncating oblique plane. A circular bottom plate of the table feeder is obliquely coupled with a truncated lower end face of the truncated, reverse pseudo-cone-shaped member. This arrangement sets the rotating shaft and the rotary vane of the table feeder such that it is inclined relative to both a horizontal axis and a vertical axis.

The bottom plate may be arranged in a horizontal orientation or in an inclined orientation and may have any suitable shape, such as a flat plate or a cone. The inclination angle of the bottom plate may be set adequately according to the properties of the particulate material. The inclination angle is preferably set in a specific angle range that accelerates the gravitational collapse of the particulate material and prevents the occurrence of an undesirable phenomenon, such as formation of lumps among the particulate material. The inclination angle of the bottom plate from a horizontal axis may be in an angle range of 5 to 40 degrees, although this range is only illustrative and not restrictive. A minimum angle of 5 degrees is set according the critical gradient for cleaning with wash water. The side plate may have an inclination angle in the range of 45 degrees to 60 degrees, although this range is only illustrative and not restrictive.

The discharger is preferably located at the deepest position of the particulate material processing vessel. One typical example of the deepest position is a bottom of a recess formed in the bottom assembly. The recess is a boundary between the bottom plate and the side plate and is preferably curved. To enhance the discharge efficiency, the rotation trajectory of the end of the rotary vane preferably passes through an opening of the discharger. In applications with a bottom plate in an inclined orientation, the particulate material gathers at the discharger by means of gravitational collapse of the particulate material and under the action of the rotary vane. The inclined orientation of the bottom plate also induces the wash water to flow toward the discharger, thereby facilitates cleaning.

In applications in which the bottom plate is in an inclined orientation, an inclination angle θ₁ of the bottom plate and an inclination angle θ₂ of the side plate from a horizontal axis are not specifically restricted but may be set to any arbitrary values that preferably satisfy a relation of θ₁ θ₂. The relationship between the diameter R₁ of the bottom plate and the diameter R₂ of the particulate material processing vane is not specifically restricted but may be set to any arbitrary values that preferably satisfy a relation R₁≦R₂. The inclination angles or the diameters are preferably related such that they assure mass flow of the particulate material. For first-in, first-out processing of the particulate material loaded in the particulate material processing vessel, a uniform downward flow of the particulate material caused by mass flow effects, both in the central area and in the peripheral area, is most desirable. An excessively steep or excessively gentle inclination angle and an excessively small or excessively large diameter may interfere with the mass flow effects.

In one application, the cone may be rotated coaxially with the rotary vane. In another application, the cone may be fixed to a shaft, and the rotary vane alone may be rotated. The rotation of the cone with the rotary vane is, however, preferable, in order to prevent the particulate material from remaining. In still another application, the cone may be fixed to an inner wall to be separated from the rotary vane. In the applications in which the cone is fixed, the cone may be fastened laterally to the inner wall of the particulate material processing vessel or may be fastened vertically to the bottom plate via a fixation shaft. A preferable example of the drive device is a motor but another type of drive device may be used instead.

The number of rotary vanes is not specifically restricted, and the table feeder may have one rotary vane or multiple rotary vanes.

In the table feeder according to the above aspect of the invention, the particulate material is fed onto the upper face of the cone, and there is a gap formed in a lower space below the cone. The primary volume through which the particulate material moves under the action of the rotary vane is restricted to a peripheral area of the bottom plate (a donut-shaped area in the planar view). As the rotary vane moves the particulate material, the particulate material may be released through the gap. This arrangement desirably lowers the load applied to the rotary vane and enables the particulate material, even that having a low fluidity, to be efficiently discharged via the discharger by means of the rotary vane.

In the table feeder of the above embodiment having a through-hole and a scraping element, if particulate material with a low fluidity aggregates in the particulate material processing vessel, the scraping element may cut and crush the particulate material that is accumulated or aggregated on the upper face of the cone, thereby enabling the crushed particulate material to flow down via the through-hole to the gap formed below the cone. This arrangement assures the smooth discharge of particulate material having a low fluidity via the discharger.

### BRIEF DESCRIPTION OF THE DRAWINGS

FIG. 1 is a partially cut-away front view diagrammatic representation of a table feeder according to a first embodiment of the invention;

FIG. 2 is a partially cut-away front view diagrammatic representation of a bottom assembly and a drive device included in the table feeder;

FIG. 3 is a plan view diagrammatic representation of the bottom assembly included in the table feeder;

FIG. 4 is an explanatory diagrammatic representation of the operation of the table feeder;

FIG. 5(a) is a top perspective view diagrammatic representation of a cone of a modified structure included in the table feeder;

FIG. 5(b) is a bottom perspective view diagrammatic representation of the cone;

FIG. 6(a) is a plan view diagrammatic representation of one modification of the cone;

FIG. 6(b) is a plan view diagrammatic representation of another modification of the cone;

FIG. 7(a) is an enlarged plan view diagrammatic representation of part of the cone;

FIG. 7(b) is a front view diagrammatic representation of a through-hole 11 and a scraping element 12;

FIG. 8(a) is a front view diagrammatic representation of a through-hole 11′ and a scraping element 12′ in one modified structure;

FIG. 8(b) is a side view diagrammatic representation of the modification of FIG. 8(a);

FIG. 8(c) is a side view diagrammatic representation of a through-hole 11″ and a scraping element 12″ in another modified structure;

FIG. 8(d) is a front view diagrammatic representation of the modification of FIG. 8(c);

FIG. 9 is a partially cut-away front view diagrammatic representation of a table feeder according to a second embodiment of the invention;

FIG. 10 is a plan view diagrammatic representation of the table feeder of the second embodiment; and

FIG. 11 is a front view diagrammatic representation of a cone, rotary vanes, and a bottom plate included in the table feeder of the second embodiment.

### DETAILED DESCRIPTION OF THE INVENTION

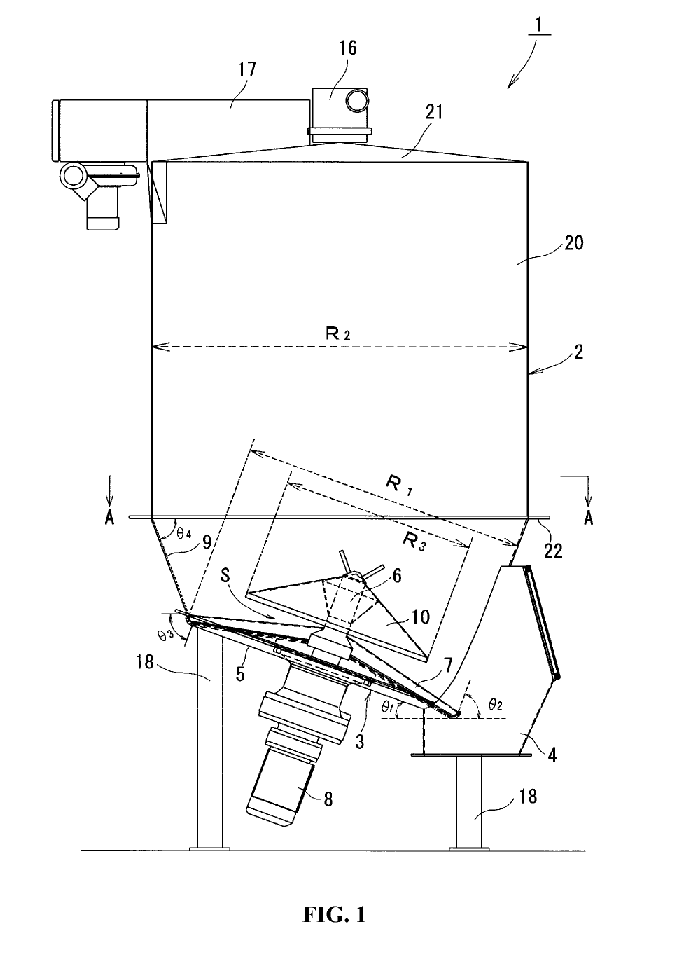

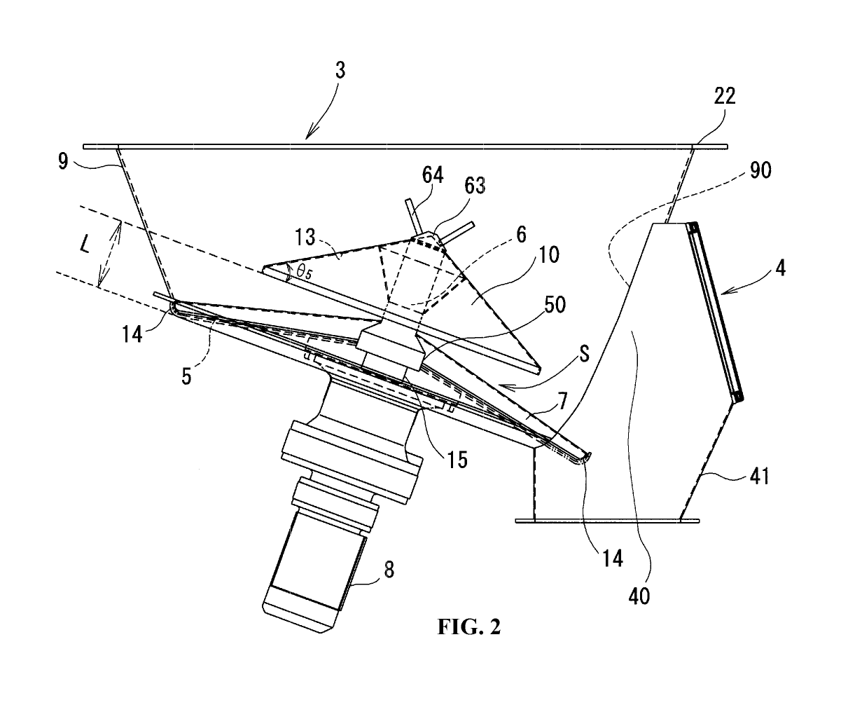

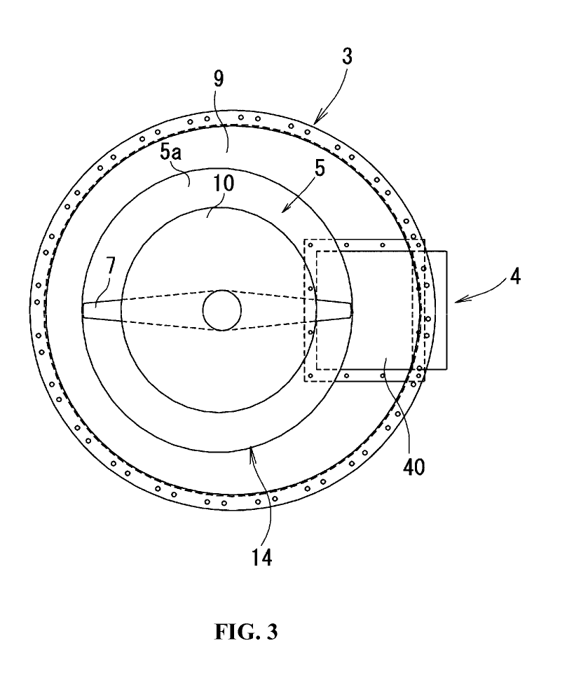

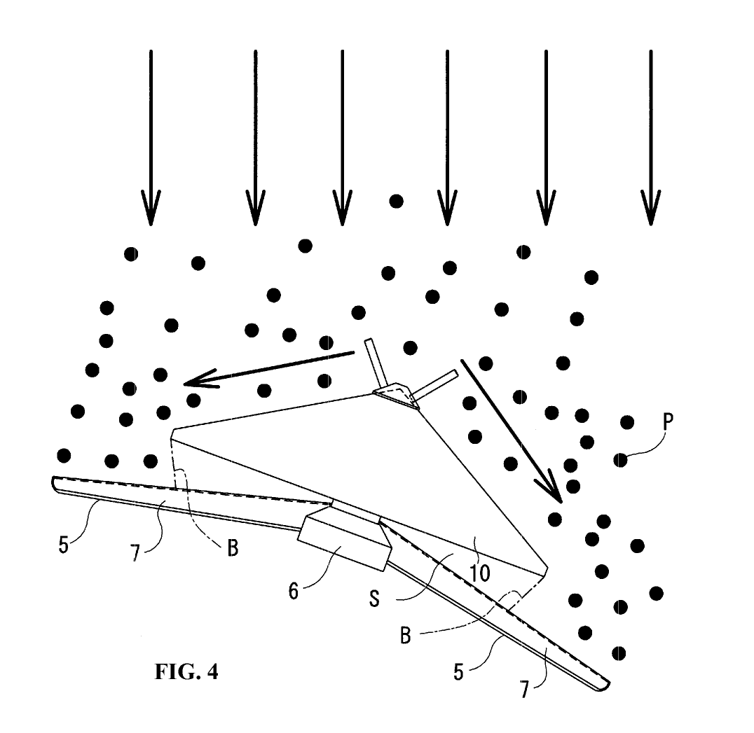

A table feeder 1 according to a first embodiment of the invention is described below with reference to the accompanied drawings. As shown in FIGS. 1 through 4, the table feeder 1 includes a bottom assembly 3 of a particulate material processing vessel 2, a discharger 4 formed in the bottom assembly 3 to allow for discharge of a particulate material P (FIG. 4) kept in the particulate material processing vessel 2, a bottom plate 5 provided in the bottom assembly 3, a rotating shaft 6 perpendicularly attached to a main face 5a of the bottom plate 5 to rotate on the center of the bottom plate 5, rotary vanes 7 rotated on the bottom plate 5 by the rotating shaft 6 to discharge the particulate material P kept in the particulate material processing vessel 2 via the discharger 4, and a drive device 8 provided to drive and rotate the rotary vanes 7. The bottom assembly 3 has the bottom plate 5 and a side plate 9 connecting with and surrounding the bottom plate 5.

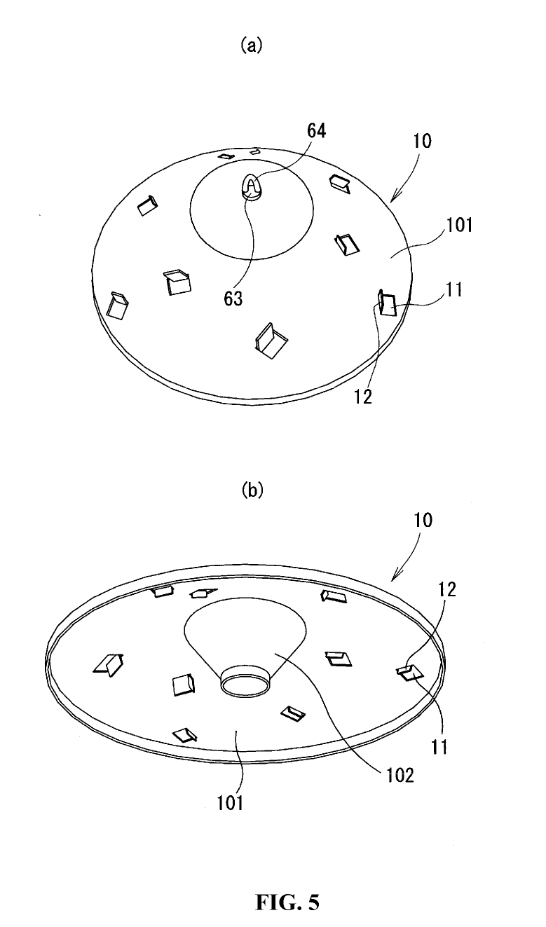

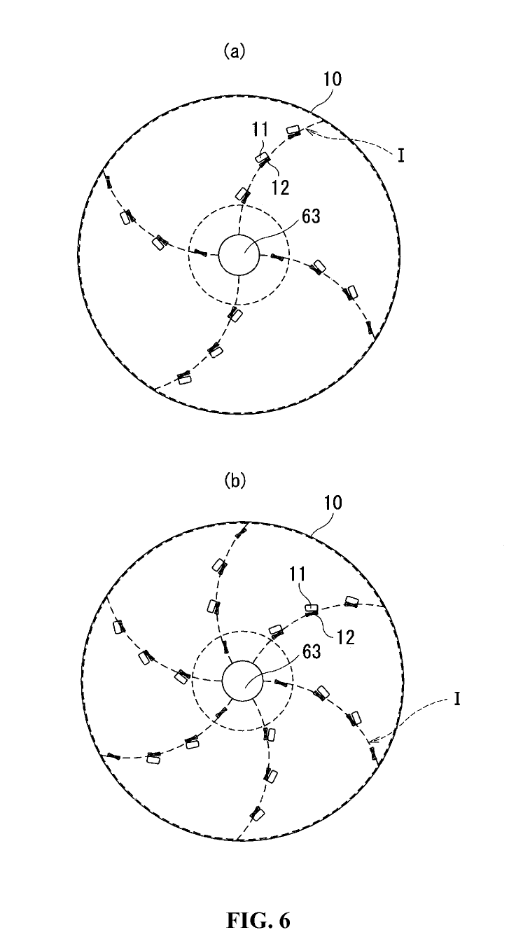

A cone 10 having a smaller diameter than the diameter of the rotary vanes 7 is provided in an upper space of the rotary vanes 7 to be arranged coaxially with the rotary vanes 7 and to extend over a central region of the rotary vanes 7. This arrangement allows the rotary vanes 7 and the cone 10 to be rotated integrally and coaxially. The cone 10 has no hole in this illustrated embodiment. The cone 10 may, however, be designed to have multiple through-holes 11 and corresponding scraping elements 12, as shown in FIGS. 5 to 6. The scraping elements 12 scrape off the particulate material P accumulated and aggregated on an upper face of the cone 10. The scraped-off particulate material P falls toward a lower face 13 of the cone 10 via the through-holes 11. This arrangement is especially suitable for particulate material P having a low fluidity. The respective components of the table feeder 1 are described below in detail.

In this illustrated embodiment, the bottom plate 5, the rotating shaft 6, and the rotary vanes 7 are arranged obliquely with respect to a horizontal axis. The bottom assembly 3 has a cross-sectional area that gradually decreases downward, and the discharger 4 is formed in a deepest section of the bottom assembly 3.

The particulate material processing vessel 2 has a cylindrical section 20 and a cone-shaped top plate 21 coupled with an upper end of the cylindrical section 20. A lower end of the particulate material processing vessel 2 is joined with an upper end of the bottom assembly 3 by means of a flange 22.

The discharger 4 has a tubular body 41 provided to extend over a discharge opening 40 formed across the side plate 9 and a recess 14 formed as a boundary between the bottom plate 5 and the side plate 9. The tubular body 41 extends from and fastened to the bottom assembly 3. An edge of the bottom plate 5 and an edge of the rotary vanes 7 are projected into an inner space of the discharger 4. The particulate material P is directed into the tubular body 41 by means of the rotary vanes 7. A rotary valve (not shown) or any equivalent element may be attached to a lower end of the tubular body 41.

The bottom plate 5 is inclined to face the side plate 9 and is joined with the side plate 9 to form the bottom assembly 3. The bottom plate 5 is a cone with inclination, and forms an elliptical shape in a planar view. A circular outer circumference of the bottom plate 5 is preferable to conform to the rotation trajectory of the rotary vanes 7. The wider area of the bottom plate 5 is not thoroughly covered by the rotation trajectory of the rotary vanes 7 and may decrease the discharge efficiency. The bottom plate 5 is integrally formed and made of steel or preferably stainless steel. The bottom plate 5 has a circular center opening 50 for attachment of the drive device 8.

The bottom plate 5 and the side plate 9 are both inclined toward the discharger 4. The bottom plate 5 has a diameter R₁ that is not greater than a diameter R₂ of an upper portion of the vessel 2. For example, the bottom plate 5 has an inclination angle θ₁=20 degrees and the side plate 9 has an inclination angle θ₂=53 degrees. The inclination angles are, however, not restricted to these values but may be any other values that preferably satisfy the relation θ₁<θ₂. The inclination angles should be set within a specific range that allows for mass flow of the particulate material P in the cylindrical body 20 and prevents disadvantageous phenomena, such as lumping. For example, the recess 14 has an angle θ₃=70 degrees, and the side plate 9 has an inclination angle of θ₄=69 degrees. The angles are, however, not restricted to these values.

The rotating shaft 6 is inserted through the opening 50 and is attached to a bearing 15 in a freely rotatable manner. A cap 63 with knobs 64 is fastened to an upper end of the rotating shaft 6. The knobs 64 may be linear elements or ring elements. Rotating the knobs 64 tightens or loosens a screw to attach and detach the cone 10 to and from the rotating shaft 6. The cone 10 is fixed to an upper portion of the rotating shaft 6, while the base of the rotary vanes 7 is fixed to a lower portion of the rotating shaft 6. This arrangement allows for integral rotation of the rotating shaft 6 with the cone 10. The two rotary vanes 7 are arranged to have a preset angle (for example, 180 degrees) and extend radially.

The side plate 9 is a truncated, reverse pseudo-cone-shaped member with a gradual downward decrease in cross-sectional area and being truncated by a plane oblique to the bottom plane of the cone. The side plate 9 has an opening 90. The cone-shaped bottom plate 5 is obliquely coupled with the side plate 9. The discharger 4 is connected with a cutting end face of the side plate 9.

The rotary vanes 7 are inclined to be gradually lowered from the base ends to the tip ends corresponding to the inclination angle of the bottom plate 5, as shown in FIG. 1. There are only slight clearances between the lower faces of the rotary vanes 7 and the upper face of the bottom plate 5.

The drive device 8 is linked with the rotating shaft 6. Rotation of the rotating shaft 6 integrally rotates the rotary vanes 7 with the cone 10.

The side plate 9 is arranged to surround the bottom plate 5 and to be extended upward from the bottom plate 5. The upper end of the side plate 9 is coupled with the cylindrical body 20.

The cone 10 includes a cone plate 101 and a reverse cone plate 102 fastened to a rear face of the cone plate 101. The reverse cone plate 102 is provided to enhance the cleaning efficiency. An upper portion of the rotating shaft 6 is inserted in the reverse cone plate 102. The ratio of the diameter R₂ of the cone 10 to the diameter R₁ of the bottom plate 5 is preferably within the range 40% to 90%, especially preferably within the range 50% to 80%. An excessively high ratio undesirably reduces the discharge efficiency, whereas an excessively low ratio undesirably increases the pressure of the particulate material. The preferable ratio of a distance L between the lower face of the bottom plate 5 and the cone 10 to the diameter R₁ of the bottom plate 5 is specifically within the range 5% to 25% at the periphery of the cone 10. An excessively high ratio interferes with formation of an interface B (FIG. 4) by an angle of repose of the particulate material P, whereas an excessively low ratio reduces a gap S to receive the released particulate material P. The cone 10 is designed to have dimensions that fall within the dimensions of the bottom assembly 3. The cone 10 has an inclination angle θ₅ within the range 20 degrees to 60 degrees. This range of the inclination angle is only illustrative and not restrictive.

The table feeder 1 also has a supply unit 16 arranged on top of the particulate material processing vessel 2 to feed a supply of the particulate material P from upstream into the vessel 2, a filter unit 17 arranged in proximity to the supply unit 16 to separate the particulate material P from the gas, and supporting legs 18 disposed to support the particulate material processing vessel 2. The supply unit 16, the filter unit 17, and the supporting legs 18 may be adequately omitted, modified, and added according to the requirements.

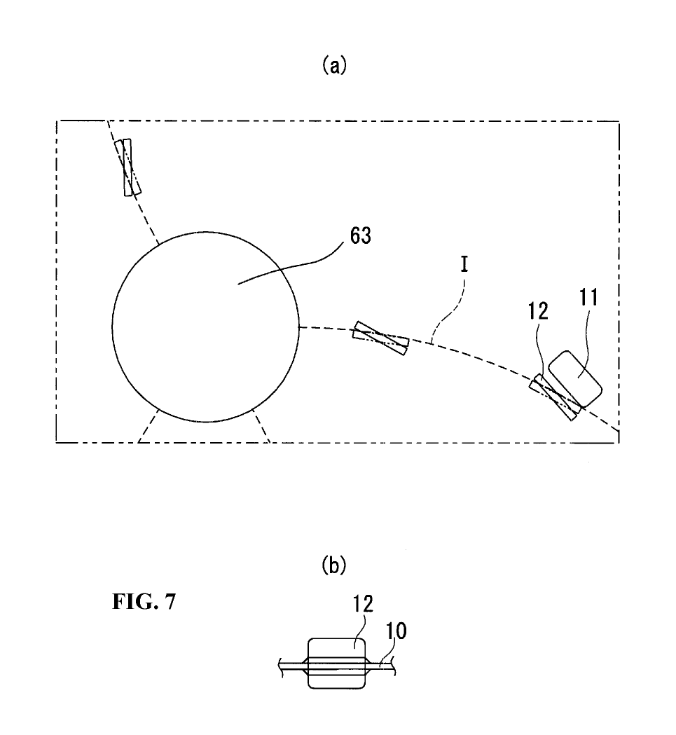

Modifications of the cone 10 are described with reference to FIGS. 5 through 8. Multiple through-holes 11 and corresponding multiple scraping elements 12 are arrayed at preset intervals or at any adequate interval along the involuted curves I indicated by a dotted line, as shown in FIGS. 6 and 7. The involuted curves I are multiple virtual lines extending radially from the cap 63 on the center of cone 10 toward the periphery. The through-holes 11 and the scraping elements 12 may be oriented in any direction that preserves function. For example, the positions of the through-holes 11 and the scraping elements 12 may deviate from the positions shown by the double-dotted lines to intersect with the involuted curves I.

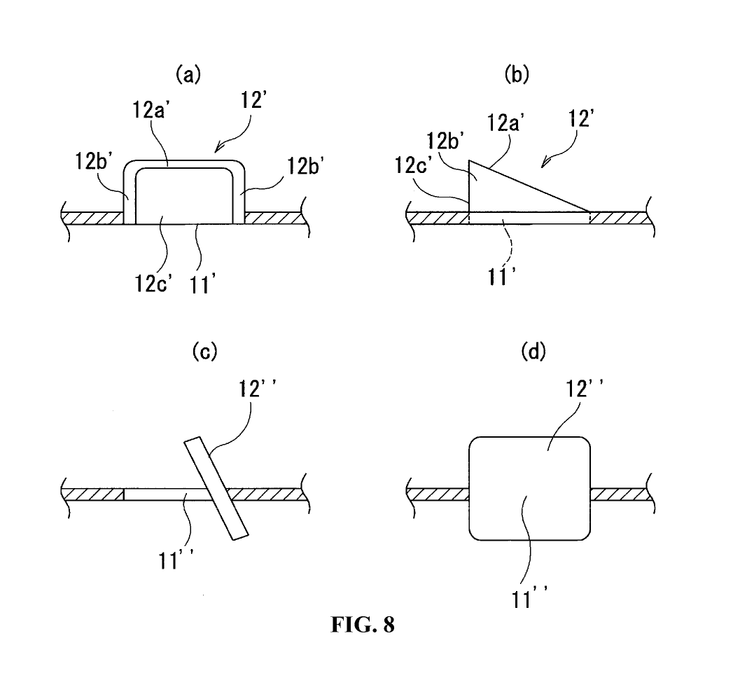

As shown in FIG. 8, the scraping elements 12 are not restricted to a rectangular shape but may be formed in any shape suitable for cutting, crushing, and scraping the aggregated particulate material P. In one illustrated example as shown in FIG. 8(a), a scraping element 12′ is a plate member that protrudes upward and includes a sloped plate 12a′ and a pair of side plates 12b′. The scraping element 12′ is arranged to extend over an upper space above a through-hole 11′ and has a front opening 12c′. In another illustrated example as shown in FIGS. 8(c) and 8(d), a scraping element 12″ is inclined with respect to a normal direction of the through-hole 11″.

The operations of these modified structures are described briefly. With rotation of the cone 10, the scraping elements 12, 12′ or 12″ cut and crush the particulate material P, causing the upper layer of the particulate material P to fall by means of gravitational collapse, then cut and crush the particulate material P, which again falls under the force of gravity. The particulate material P is cut and crushed successively in this manner. The crushed particulate material P flows along the through-holes 11, 11′, or 11″ to the lower face 13 and is discharged out to the discharger 4 by the rotary vanes 7.

The operations and the effects of the table feeder 1 according to the first embodiment are described. The cone 10 is arranged to extend over the rotary vanes 7 across the gap S. This arrangement effectively reduces the particulate material pressure applied onto the bottom plate 5 and the rotary vanes 7. The interface B (FIG. 4) between the particulate material P and the gap S is formed according to the characteristic angle of repose of the particulate material P. This arrangement enables the rotary vanes 7 to release the particulate material P to the gap S, thus reducing the load applied onto the rotary vanes 7 and assuring high rotational power from the rotary vanes 7. Reducing the particulate material pressure applied to the bottom plate 5 reduces the required thickness of the bottom plate 5 and conserves power applied to the drive device for rotating the rotary vanes 7. This arrangement further facilitates mass flow in the cylindrical body 20 and increases the discharge efficiency.

The cone 10 has through-holes 11 and the scraping elements 12, provided especially for particulate materials P with a low fluidity, for example, crystalline materials such as granulated sugar, or bran having a significant oil content. The through-holes 11 and the scraping elements 12 work to cut and crush aggregated particulate material P. This assures the smooth rotation of the rotary vanes 7 and the resulting smooth discharge of the particulate material P to the discharger 4.

The combination of the swirling flow generated by the rotary vanes 7 and the gravitational flow causes the particulate material P on the inclined bottom plate 5 to flow toward the discharger 4. The gravitational flow causes the particulate material P in the inner region of the side plates 9 to flow toward the discharger 4. Namely, the cooperation between the swirling force of the rotary vanes 7 and the gravitational collapse of the particulate material P reduces the pressure applied to the bottom plate 5 and reduces the thickness requirements for the bottom plate 5 and the size requirements of the drive device 8. This arrangement also prevents disadvantageous phenomena, such as aggregation of the particulate material P, and guides the particulate material P to the discharger 4, thus enhancing the discharge efficiency.

To facilitate cleaning of the table feeder 1 by washing out the remaining particulate material P with wash water, the structure of the table feeder 1 allows the wash water to flow into the discharger 4, arranged on one side of the bottom plate 5, thus facilitating maintenance. Only a narrow clearance space is present between the lower face of the rotary vanes 7 and the upper face of the bottom plate 5. This desirably prevents large amounts of the particulate material P from remaining in the clearance and assures removal of the particulate material P from the bottom assembly 3. The structure of the table feeder 1 effectively eliminates the causes of potential contamination and provides for hygienic and easy cleaning of the equipment in conformity with the HACCP and GMP policies.

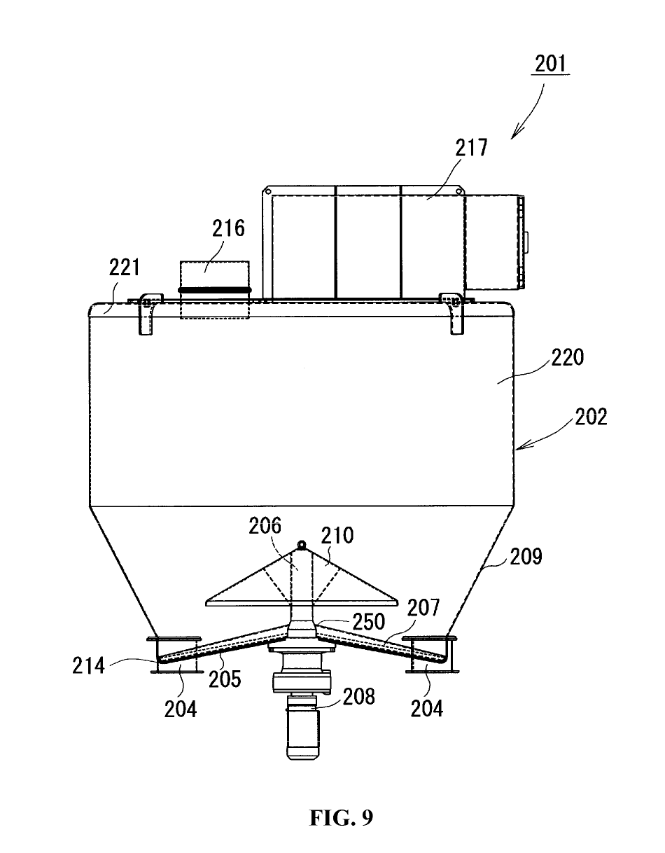

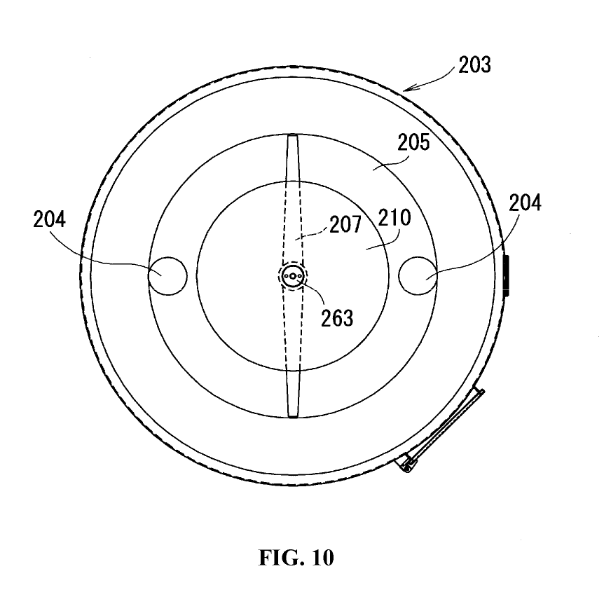

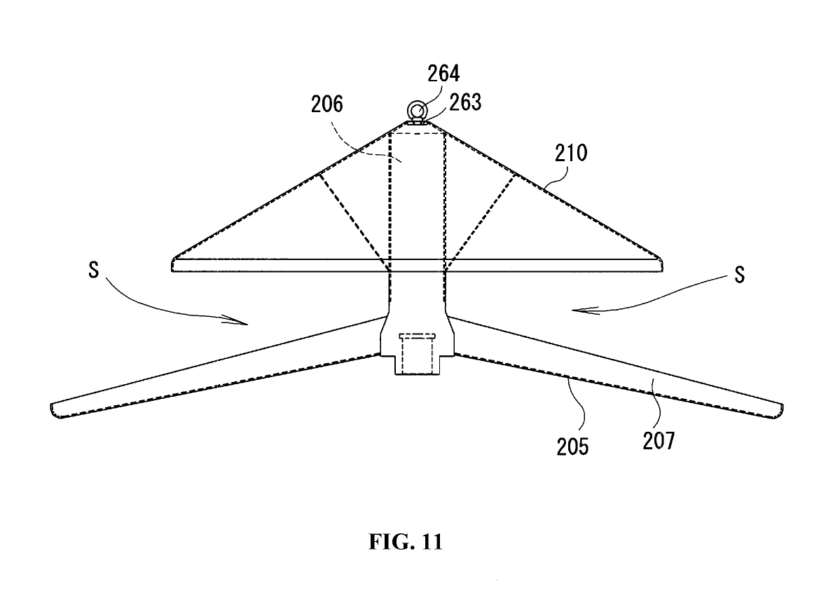

A table feeder 201 according to a second embodiment of the invention is described, as illustrated in FIGS. 9 through 11. The table feeder 201 of the second embodiment has a structure similar to that of the table feeder 1 of the first embodiment. Similar components are indicated by analogous numerals in the 200s and are not specifically explained here. The difference from the first embodiment is explained below. The table feeder 201 has a bottom plate 205 and two rotary vanes 207 rotating on the bottom plate 205. The bottom plate 205 is horizontally arranged and has a cone shape. The bottom plate 205 is inclined so that it gradually slopes from the center opening 250 toward the periphery. The bottom plate 205 is designed to hold the particulate material P placed thereon and has a fixed inclination angle. An arc-shaped recess 214 is formed around the bottom plate 205. A knob 264 is a ring element.

A side plate 209 is a truncated cone member with a truncated lower end. The bottom plate 205 is substantially horizontally coupled with the lower end of the side plate 209. Multiple (two in the illustrated example of FIG. 9) small-sized pseudo-cylindrical dischargers 204 are provided in proximity to the rotation trajectory of the ends of the rotary vanes 207.

In the table feeder 201 of the second embodiment, the bottom plate 205 receiving the load of the particulate material P is inclined so that it gradually slopes from the center toward the periphery. The load of the particulate material P applied onto the bottom plate 205 has a large secondary moment corresponding to the inclination angle of the bottom plate 205. This arrangement desirably allows for the thickness of the bottom plate 205 to be reduced relative to the thickness of conventional table plates, thus reducing the weight and cost of the overall table feeder. The two rotary vanes 207, driven to rotate on the bottom plate 205, are inclined in the same manner as the bottom plate 205. A large clearance space between the lower face of the rotary vanes 207 and the upper face of the bottom plate 205 is not necessary due to the reduced load of the particulate material P. Namely, there is an extremely small clearance. This arrangement desirably prevents large amounts of the particulate material P from remaining in the clearance but assures the effective removal of the particulate material P. For detailed descriptions of the other components of the second embodiment, refer to Japanese Patent Laid-Open No. 2005-193997.

The embodiments and their modifications discussed above are to be considered in all aspects as illustrative and not restrictive. Many other modifications, changes, and alterations may be made without departing from the scope of the main characteristics of this invention. All changes within the meaning and range of equivalency of the claims are intended to be embraced therein. For example, the inclination, the shape, the size, and the arrangement of the cone 10 are not restricted to the above embodiments but may be set arbitrarily within the scope of the invention. The table feeder 1 has two rotary vanes 7. The number of rotary vanes 7 is, however, not restricted to two but may be determined arbitrarily. The sizes, the shapes, and the positions of the bottom plate 5 and the rotary vanes 7 are not restricted to the above embodiments but may be set arbitrarily within the scope of the invention. In the first embodiment, the bottom plate 5 has an inclination angle θ₁=20 degrees. The bottom plate 5 may have a steeper inclination angle within the range 21 degrees to 40 degrees, for example, 25 degrees, or may have a gentler inclination angle within the range 5 degrees to 19 degrees. The inclination angle may be determined by taking into account the efficiency of washing with wash water.

All publications and patent applications mentioned in this specification are indicative of the level of skill of those skilled in the art to which this invention pertains. All publications and patent applications mentioned in this specification are herein incorporated by reference to the same extent as if each individual publication or patent application mentioned in this specification was specifically and individually indicated to be incorporated by reference.

The invention claimed is:

1. A table feeder, comprising:
a particulate material processing vessel;
a discharger provided in a bottom assembly of the particulate material processing vessel to discharge a particulate material kept in the particulate material processing vessel;
a bottom plate included in the bottom assembly;
a rotating shaft protruding upward from the bottom plate to rotate on the center of the bottom plate;
a rotary vane disposed on the bottom plate to rotate by the rotating shaft and discharge the particulate material kept in the particulate material processing vessel via the discharger; and
a drive device configured to drive and rotate the rotary vane, wherein
the bottom assembly comprises the bottom plate and a side plate coupled with the bottom plate to surround the bottom plate, and
a cone having a smaller diameter than a diameter of the rotary vane is provided in an upper space of the rotary vane to extend over a center area of the rotary vane.

2. The table feeder of claim 1, wherein the cone has a through-hole with a scraping element that scrapes off the particulate material accumulated and aggregated on an upper face of the cone and causes the scraped particulate material to fall down through the through-hole to a lower face of the cone.
